(19) United States
(12) Patent Application Publication
(10) Pub. No.: US 2012/0105798 A1
(43) Pub. Date: May 3, 2012

(54) EYEWEAR WITH BUILT-IN LIGHT DEVICE

(76) Inventor: Billy Chen, New York, NY (US)

(21) Appl. No.: 12/917,057

(22) Filed: Nov. 1, 2010

(51) Int. Cl. G02C 11/04

(52) U.S. Cl. 351/158

(57) ABSTRACT

An eyewear includes a front portion, two temple portions and a built-in light device located within each temple portion. The front portion includes at least one lens rim and a protrusion extending substantially perpendicularly to a plane of the rim. Each temple portion includes a connection portion hingedly connected to the protrusion of the front portion and a cavity formed therein. The built-in light device has a pre-fabricated light module, which is positioned within the cavity. The light module includes a power source, a switch and a light source. The cavity is enclosed by a cover securing the pre-fabricated light module within the cavity and under the cover. The cavity and the cover includes corresponding recesses sized to encase the light source and to allow the light source to be visible from outside the front portion.

### BACKGROUND

The Application generally relates to the field of functional eyewear.

To enhance utility of eyewear, numerous attachments have been designed for incorporation into such eyewear. For example, U.S. Pat. No. 6,974,226 discloses a light assembly that can be magnetically attached to a pair of glasses. This disclosed design requires its user to carry the light assembly separately from the glasses and to attach and remove the assembly to/from the glasses, as necessary. Accordingly, a user has to constantly remember to carry the light assembly and that is inconvenient. The user is further inconvenienced by the necessity of attaching and detaching the light assembly.

### SUMMARY

In one general aspect of the invention, an eyewear with an incorporated light device is provided.

In another general aspect of the invention, an eyewear is provided which includes a front portion, two temple portions and a built-in light device located within each temple portion. The front portion includes at least one lens rim and a protrusion extending substantially perpendicularly to a plane of the rim. Each temple portion includes a connection portion hingedly connected to the protrusion of the front portion and a cavity formed therein. The built-in light device has a pre-fabricated light module, which is positioned within the cavity. The light module includes a power source, a switch and a light source. The cavity is enclosed by a cover securing the pre-fabricated light module within the cavity and under the cover. The cavity and the cover includes corresponding recesses sized to encase the light source and to allow the light source to be visible from outside the front portion.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is a front view of the eyewear in accordance with the preferred embodiment of the present invention.

FIG. 2 is a top view of the eyewear in accordance with the preferred embodiment of the present invention.

FIG. 3 is a front perspective view of the eyewear in accordance with the preferred embodiment of the present invention.

FIG. 4 is a schematic diagram of the pre-fabricated light module positioned within the cavity of the temple portion.

FIG. 5 is a schematic diagram of the connection between the front portion and the temple portion.

### DETAILED DESCRIPTION OF THE PREFERRED EMBODIMENTS AND THE DRAWINGS

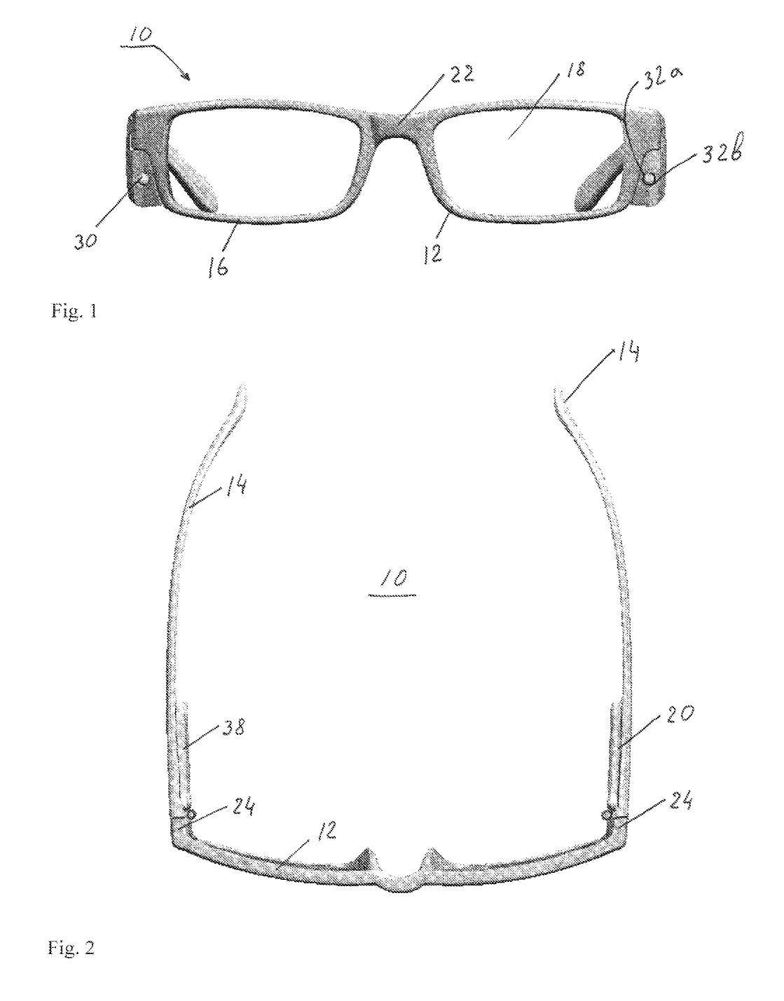

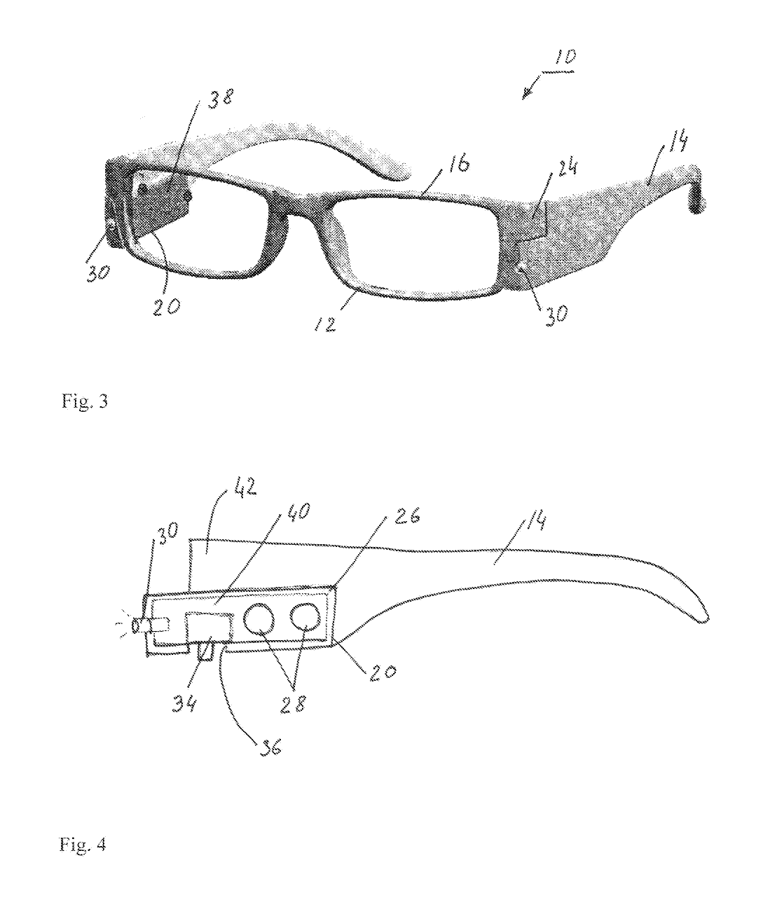

As shown in FIG. 1, in the preferred embodiment, eyewear 10 includes a front portion 12 and two temple portions 14. The front portion has two lens rims 16 encasing lenses 18. Lens rims are connected to each other with a nose bridge 22. Further, as shown in FIGS. 2-3, each rim 16 includes a protrusion 24 extending from the rim substantially perpendicularly to the plane of the rim.

Each temple portion includes a built-in light device 20. As shown in FIG. 4, each light device 20 includes a cavity 26 formed within temple portion 14. A pre-fabricated light module 40 is positioned within the cavity and includes a power source 28, switch 34 and a light source 30. Power source 28 is preferably a removable and replaceable battery. Switch 34 is movable between two positions, i.e., the “on” and “off” positions. All components of the light module 40 are preferably formed on the same substrate and are electrically connected to each other such that when switch 34 is moved into the “on” position, light source 30 turns on, and when switch 34 is moved into the “off” position, light source 30 turns off. In the preferred embodiment, cavity 26 is sized to fit the light module snugly and includes a recess 36 allowing switch 34 to protrude outside the cavity and to move within the recess.

Further, as shown in FIGS. 1-3, cavity 26 is preferably enclosed by a cover 38 connectable to the cavity by a plurality of screws. Any other known means of fastening may be utilized instead of screws. Cover 38 and cavity 26 have corresponding openings 32a and 32b encasing the light source 30. As shown in FIG. 1, when the cover is attached to the cavity and the eyewear is fully assembled, light source 30 is visible from outside through openings 32a and 32b and is positioned immediately below protrusion 24 of the front portion. Moreover, switch 34 protrudes through recess 36 allowing a wearer to move the switch.

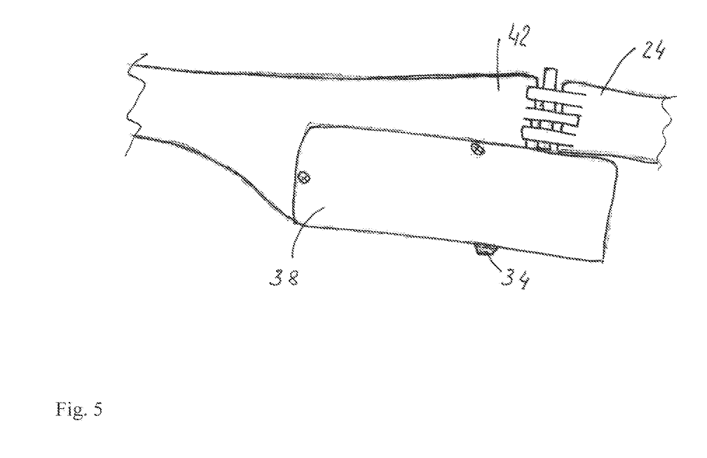

Each temple portion 14 further includes a connection portion 42 preferably located immediately above built-in light device 20 and configured to be hingedly attached to protrusion 24. As shown in FIG. 5, in the preferred embodiment, connection portion 42 and protrusion 24 each includes at least one prong connected to each other with a hinge pin. When viewed from the front, the hinged connection is not visible. Although the connection between the temple portion and the front portion may be accomplished differently, positioning such connection at protrusion 24 angled perpendicularly to the front portion and at connection portion 42 located above the light device eliminates possible interference with the light emitted from light source 30 and provides for an aesthetically pleasing design by hiding the hinged connection from an outside viewer.

In use, the wearer opens the temple portions and positions the eyewear on his/her face. Light sources 30 are then visible at the front portion and directed at an object at which the wearer is looking. The wearer may selectively turn on the built-in light device by moving the protruding switch into the “on” position and illuminating the light sources. Moreover, because the light devices in the two temple portions are independent of one another, wearer has a choice of turning on the left light, the right light or both, depending on a particular need.

While there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim as follows:

1. An eyewear comprising:
a front portion having at least one lens rim and a protrusion extending substantially perpendicularly to a plane of the rim;
a temple portion having a connection portion hingedly connected to the protrusion of the front portion, the temple portion further having a cavity formed therein; and
a built-in light device having a pre-fabricated light module positioned within the cavity of the temple portion, the light module including a power source, a switch and a light source, the built-in light device further having a cover removably attached to the cavity of the temple portion securing the pre-fabricated light module within the cavity under the cover, the cavity and the cover having corresponding recesses sized to encase the light source and to allow the light source to be visible from outside the front portion.

2. The eyewear of claim 1, wherein the cavity of the temple portion includes an aperture, wherein the switch protrudes through the aperture, the switch being movable between at least two positions, and wherein the aperture is sized to accommodate the movement of the switch.

3. The eyewear of claim 1, wherein the cavity of the temple portion is sized to snugly fit the pre-fabricated light module.

4. The eyewear of claim 1, wherein the temple portion further comprises a connection portion located immediately above the cavity, the connection portion being hingedly attached to the protrusion of the front portion so as to hingedly connect the front portion to the temple portion.

5. The eyewear of claim 1, wherein the cover is attached to the cavity with a plurality of screws.
